(19) United States
(12) Patent Application Publication
(10) Pub. No.: US 2004/0133795 A1
(43) Pub. Date: Jul. 8, 2004

(54) Method and system for handling multiple security protocols in a processing system

(76) Inventor: Eric Murray, Los Gatos, CA (US)

Correspondence Address: SAWYER LAW GROUP LLP, P O BOX 51418, PALO ALTO, CA, 94303, US

(21) Appl. No.: 10/205,824

(22) Filed: Jul. 26, 2002

(51) Int. Cl. H04L 9/00

(52) U.S. Cl. 713/200

(57) ABSTRACT

Aspects for handling multiple security protocols in a processing system are described. The aspects include utilization of an adaptable computing engine (ACE) as a security processor within a processing system on a computer network. Reconfiguration of the security processor occurs as needed to implement at least two security protocols of the computer network.

### FIELD OF THE INVENTION

The present invention relates to a reconfigurable security processor for handling multiple security protocols in a processing system.

### BACKGROUND OF THE INVENTION

As the use of the Internet expands with e-business and e-commerce, secure transactions are of paramount concern to more and more consumers and companies. Traditionally, security has been implemented using protocols such as the Internet Protocol Secure (IPSec) architecture or the Secure Sockets Layer (SSL)/Transport Layer Security (TLS) architecture. With either architecture, algorithms are employed to perform symmetric cryptography and public key cryptography (PKC). With symmetric cryptography, the algorithms include, for example, data encryption standard (DES), triple DES, advanced encryption standard, and ARC4. Diffie-Hellman and Rivest-Shamir-Adleman (RSA) are two of the more popular PKC algorithms.

With the differing algorithms and packet structures of the protocols, security processor solutions usually require hardware dedicated to handle each architecture, where multiple hardware units support the multiple algorithms for all of the protocols. For example, currently, IPSec needs very fast DES/3DES, while SSL/TLS uses RSA, random numbers, RC4/RC2/DES encyption, and SHA1 or MD5 MACS. For those solutions that attempt to handle multiple protocols in a single integrated circuit chip, the dedicated hardware required for each protocol increases chip size and/or diminishes performance. Diminished performance also occurs for those solutions that employ software to implement some of the protocol or algorithms. Further problems are encountered as the protocols change frequently when security holes in them are found, while the algorithms also change when newer, stronger ciphers appear. Other changes can result from changes in governmental export regulations, i.e., from allowing the export of 56-bit symmetric ciphers to the export of 64-bit symmetric ciphers. While traditional hardware may be able to change between algorithms if the same underlying hard problem (i.e., modular exponentiation) or basic constructs are used in the same way, the change can only be handled if the designer knew about the algorithms beforehand and then only with the help of software.

Accordingly, a need exists for a reconfigurable security processor that can handle multiple security protocols and allow changes in configuration as needed. The present invention addresses such a need.

### SUMMARY OF THE INVENTION

Aspects for handling multiple security protocols in a processing system are described. The aspects include utilization of an adaptable computing engine (ACE) as a security processor within a processing system on a computer network. Reconfiguration of the security processor occurs as needed to implement at least two security protocols of the computer network.

Through the present invention, a security processor is provided that is able to change with the introduction to new algorithms in the field. Further, the security processor in the present invention is able to be adjusted while running to deal with differing amounts of traffic in different protocols. In addition, by being reconfigurable, the security processor can implement multiple protocols in a single chip having a smaller size than currently is capable with dedicated security processor approaches that attempt to handle multiple protocols. These and other advantages will become readily apparent from the following detailed description and accompanying drawings.

### BRIEF DESCRIPTION OF THE DRAWINGS

FIG. 1 is a block diagram illustrating an adaptive computing engine.

FIG. 2 is a block diagram illustrating, in greater detail, a reconfigurable matrix of the adaptive computing engine.

FIG. 3 illustrates a block diagram of an adaptable security processor within at least one system on a network in accordance with the present invention.

FIG. 4 illustrates a diagram of a digitation file in accordance with the present invention.

### DETAILED DESCRIPTION OF THE INVENTION

The present invention relates to a reconfigurable security processor. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The following discussion of a reconfigurable security processor in a preferred embodiment utilizes adaptive silicon provided as an adaptive computing engine (ACE). A more detailed discussion of the aspects of an ACE are provided in co-pending U.S. patent application Ser. No. 09/815,122 entitled “Adaptive Integrated Circuitry with Heterogeneous and Reconfigurable Matrices of Diverse and Adaptive Computational Units Having Fixed, Application Specific Computational Elements,” filed Mar. 22, 2001, and assigned to the assignee of the present invention. Portions of that discussion are presented in the following in order to more full illustrate the aspects of the present invention.

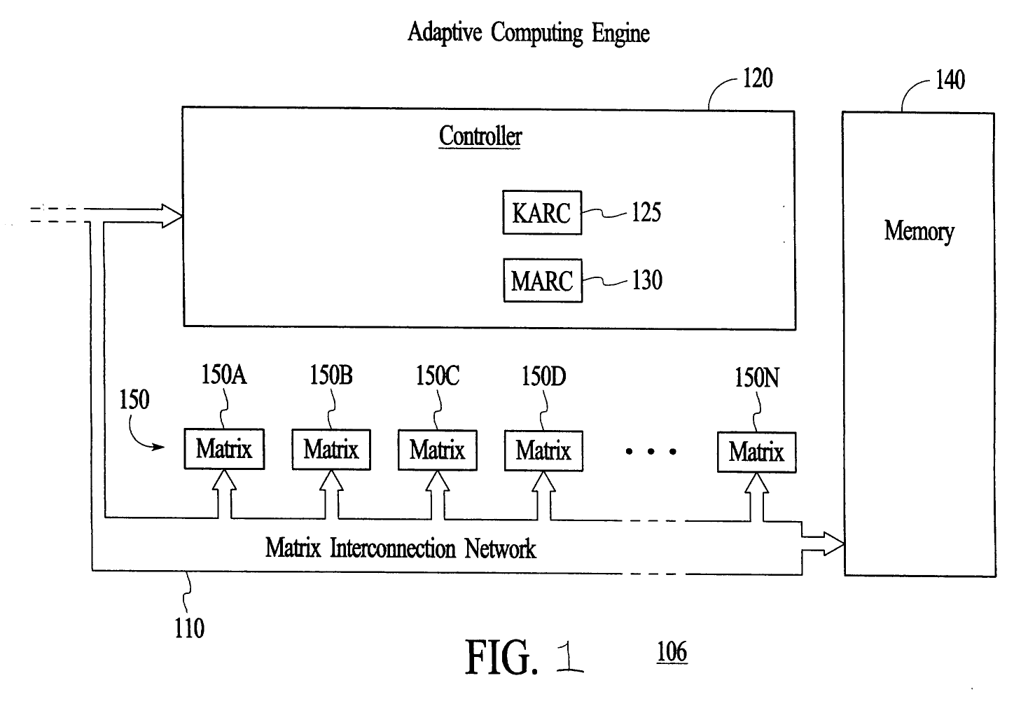

FIG. 1 is a block diagram illustrating an adaptive computing engine (“ACE”) 106 that includes a controller 120, one or more reconfigurable matrices 150, such as matrices 150A through 150N as illustrated, a matrix interconnection network 110, and preferably also includes a memory 140.

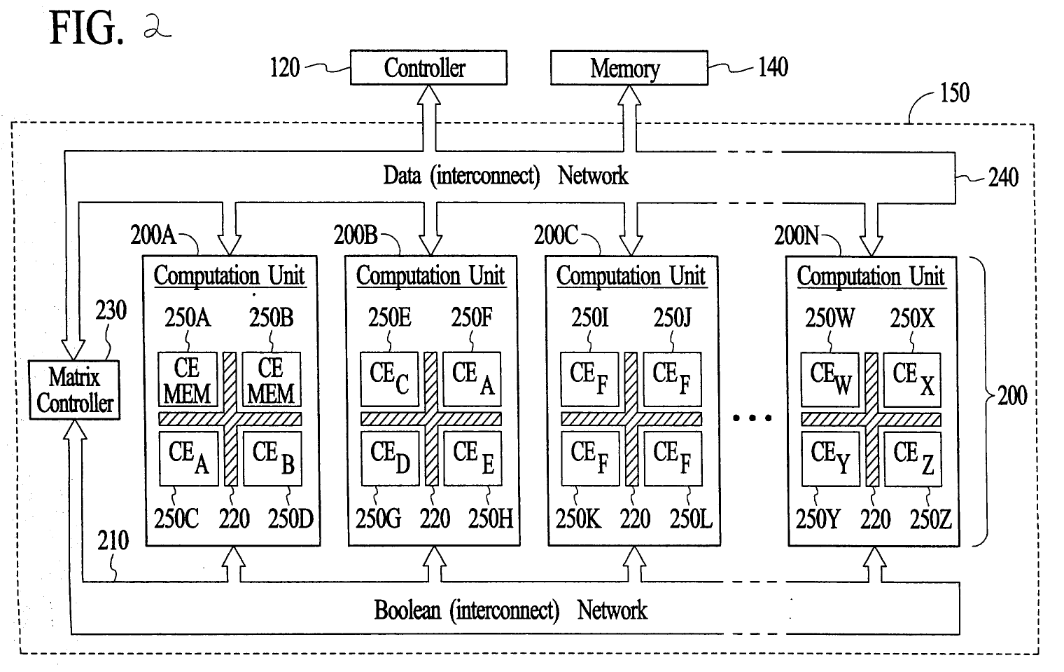

FIG. 2 is a block diagram illustrating, in greater detail, a reconfigurable matrix 150 with a plurality of computation units 200 (illustrated as computation units 200A through 200N), and a plurality of computational elements 250 (illustrated as computational elements 250A through 250Z. As illustrated in FIG. 2, any matrix 150 generally includes a matrix controller 230, a plurality of computation (or computational) units 200, and as logical or conceptual subsets or portions of the matrix interconnect network 110, a data interconnect network 240 and a Boolean interconnect network 210. The Boolean interconnect network 210 provides the reconfigurable interconnection capability between and among the various computation units 200, while the data interconnect network 240 provides the reconfigurable interconnection capability for data input and output between and among the various computation units 200. It should be noted, however, that while conceptually divided into reconfiguration and data capabilities, any given physical portion of the matrix interconnection network 110, at any given time, may be operating as either the Boolean interconnect network 210, the data interconnect network 240, the lowest level interconnect 220 (between and among the various computational elements 250), or other input, output, or connection functionality.

Continuing to refer to FIG. 2, included within a computation unit 200 are a plurality of computational elements 250, illustrated as computational elements 250A through 250Z (collectively referred to as computational elements 250), and additional interconnect 220. The interconnect 220 provides the reconfigurable interconnection capability and input/output paths between and among the various computational elements 250. Each of the various computational elements 250 consist of dedicated, application specific hardware designed to perform a given task or range of tasks, resulting in a plurality of different, fixed computational elements 250. Utilizing the interconnect 220, the fixed computational elements 250 may be reconfigurably connected together to execute an algorithm or other function, at any given time.

In a preferred embodiment, the various computational elements 250 are designed and grouped together, into the various reconfigurable computation units 200. In addition to computational elements 250 which are designed to execute a particular algorithm or function, such as multiplication, other types of computational elements 250 are also utilized in the preferred embodiment. As illustrated in FIG. 2, computational elements 250A and 250B implement memory, to provide local memory elements for any given calculation or processing function (compared to the more “remote” memory 140). In addition, computational elements 2501, 250J, 250K and 250L are configured (using, for example, a plurality of flip-flops) to implement finite state machines and to provide local processing capability, especially suitable for complicated control processing.

With the various types of different computational elements 250, which may be available, depending upon the desired functionality of the ACE 106, the computation units 200 may be loosely categorized. A first category of computation units 200 includes computational elements 250 performing linear operations, such as multiplication, addition, finite impulse response filtering, and so on. A second category of computation units 200 includes computational elements 250 performing non-linear operations, such as discrete cosine transformation, trigonometric calculations, and complex multiplications. A third type of computation unit 200 implements a finite state machine, such as computation unit 200C as illustrated in FIG. 2, particularly useful for complicated control sequences, dynamic scheduling, and input/output management, while a fourth type may implement memory and memory management, such as computation unit 200A as illustrated in FIG. 2. Lastly, a fifth type of computation unit 200 may be included to perform digitation-level manipulation, such as for encryption, decryption, channel coding, Viterbi decoding, and packet and protocol processing (such as Internet Protocol processing).

Referring to FIG. 3, the ability to perform protocol processing via an ACE is utilized in accordance with the present invention to provide a security processor 201 within at least one data processing system 203a, such as a personal computer, interconnected to other data processing systems 203b-203n, via a network 205, e.g., the Internet. Based on the reconfiguration capabilities of the ACE, the security processor 201 in accordance with the present invention handles multiple security protocols, e.g., IPSec and SSL, and alters its processing as needed to accommodate the protocols and/or cryptographic algorithms being used in the network 205. Thus, if traffic loads shift between protocols, e.g., from IPSec to SSL, the security processor 201 can switch its processing to match the network traffic of packets being received. Alternatively, adjustments can be made to implement new protocols and cryptographic algorithms, enabling the security processor 201 to keep up with changes as security holes are found in protocols and appropriate fixes are made.

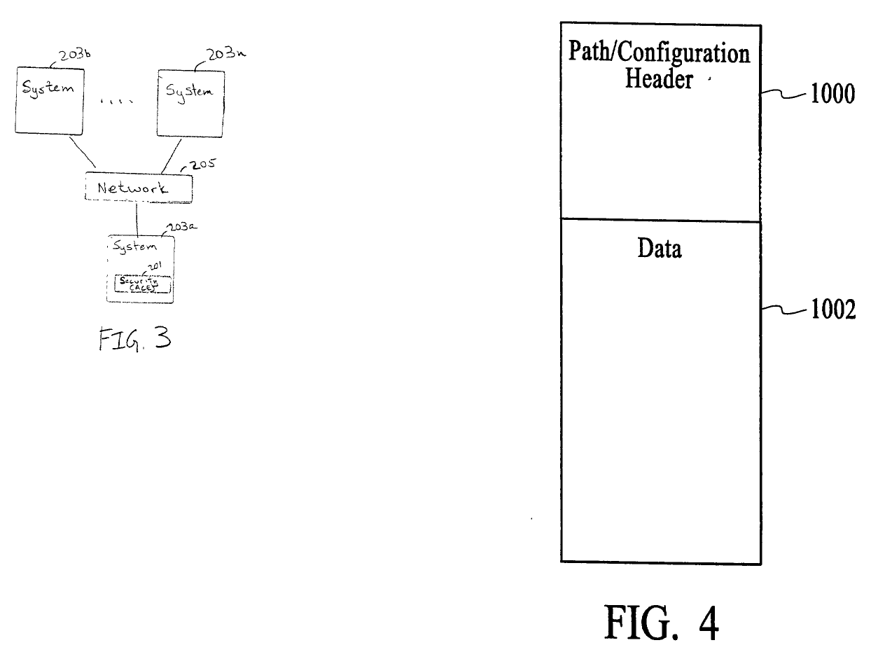

In order to achieve the adjustments, suitably an alteration in the programming of the security processor 201 is performed. A digitation file provides the programming, and for purposes of this disclosure, a digitation file refers to a tight coupling (or interdigitation) of data and configuration (or other control) information, within one, effectively continuous stream of information. As illustrated in the diagram of FIG. 4, the continuous stream of data can be characterized as including a first portion 1000 that provides adaptive instructions and configuration data and a second portion 1002 that provides data to be processed. This coupling or commingling of data and configuration information is referred to as a “silverware” module and helps to enable real-time reconfigurability. For example, as an analogy, a particular configuration of computational elements, as the hardware to execute a corresponding algorithm, may be viewed or conceptualized as a hardware analog of “calling” a subroutine in software that may perform the same algorithm. As a consequence, once the configuration of the computational elements has occurred, as directed by the configuration information, the data for use in the algorithm is immediately available as part of the silverware module. The immediacy of the data, for use in the configured computational elements, provides a one or two clock cycle hardware analog to the multiple and separate software steps of determining a memory address and fetching stored data from the addressed registers. This has the further result of additional efficiency, as the configured computational elements may execute, in comparatively few clock cycles, an algorithm which may require orders of magnitude more clock cycles for execution if called as a subroutine in a conventional microprocessor or DSP.

This use of silverware modules, as a commingling of data and configuration information, in conjunction with the real-time reconfigurability of heterogeneous and fixed computational elements 250 to form different and heterogeneous computation units 200 and matrices 150, enables the security processor 201 to have multiple and different modes of operation. Thus, as new protocols and/or algorithms are introduced, the security processor 201 is able to be reconfigured to handle them. In this manner, there is substantially no risk of the security processor 201 becoming out-dated, as can occur with most dedicated hardware solutions. Further, with the real-time configurability of the ACE architecture, processing need not be delayed during the alterations to reconfigure the security processor.

From the foregoing, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

What is claimed is:

1. A method for handling multiple security protocols in a processing system, the method comprising the steps of:
(a) utilizing an adaptable computing engine (ACE) as a security processor within a processing system on a computer network; and
(b) reconfiguring the security processor as needed to implement at least two security protocols of the computer network.

2. The method of claim 1 wherein the reconfiguring step (b) further comprises the step of (b1), reconfiguring the security processor to implement a change in protocol.

3. The method of claim 2 wherein network traffic determines a change in protocol.

4. The method of claim 2 wherein the change in protocol further comprises a new protocol.

5. The method of claim 2 wherein the change in protocol further comprises a change in a cryptographic algorithm used by a protocol.

6. The method of claim 1 wherein the at least two security protocols further comprise IPSec and SSL protocols.

7. A system for handling multiple security protocols, the system comprising:
a network of data processing systems; and
a security processor within at least one of the data processing systems, the security processor being capable of reconfiguring in real-time to implement at least two security protocols.

8. The system of claim 7 wherein the security processor further comprises an adaptable computing engine (ACE).

9. The system of claim 7 wherein the network further comprises a plurality of processing systems communicating via the Internet.

10. The system of claim 7 wherein the at least two security protocols further comprise IPSec and SSL protocols.

11. The system of claim 7 wherein the security processor reconfigures to implement a change in protocol.

12. The system of claim 11 wherein network traffic determines a change in protocol.

13. The system of claim 11 wherein a change in protocol further comprises a new protocol.

14. The system of claim 11 wherein a change in protocol further comprises a change in a cryptographic algorithm used by a protocol.

15. A method for handling multiple security protocols, the method comprising the steps of:
(a) utilizing a security processor within a processing system on a computer network; and
(b) adapting the security processor in real-time to implement any security protocol being used

16. The method of claim 15 wherein the utilizing step (a) further comprises the step of (a1), utilizing an adaptable computing engine (ACE) as a security processor.

17. The method of claim 15 wherein the adapting step (b) further comprises the step of (b1), adapting for a change to a new security protocol.

18. The method of claim 15 wherein the adapting step (b) further comprises the step of (b1), adapting for a change to a cryptographic algorithm used by a protocol.
